(19) United States
(12) Patent Application Publication
(10) Pub. No.: US 2006/0089034 A1
(43) Pub. Date: Apr. 27, 2006

(54) Buckling structure

(76) Inventor: Yi-Jen Chen, Taipei (TW)

Correspondence Address: RABIN & Berdo, PC, 1101 14TH STREET, NW, SUITE 500, WASHINGTON, DC, 20005, US

(21) Appl. No.: 11/239,093

(22) Filed: Sep. 30, 2005

(30) Foreign Application Priority Data
Oct. 26, 2004 (TW) 93132398

(51) Int. Cl. H01R 3/00

(52) U.S. Cl. 439/164

(57) ABSTRACT

A buckling structure for buckling a first housing with a first lateral plate and a second housing is provided. The buckling structure includes a first baffle and a second baffle. The first baffle having a first buckling portion is disposed in the first housing and is substantially parallel to the first lateral plate. The second baffle having a second portion is disposed in the second housing. The first buckling portion is buckled with the second buckling portion when the second baffle is inserted between the first baffle and the lateral plate, so that the first housing and the second housing are combined tightly.

This application claims the benefit of Taiwan application Serial No. 93132398, filed Oct. 26, 2004, the subject matter of which is incorporated herein by reference.

### BACKGROUND OF THE INVENTION

1. Field of the Invention

The invention relates in general to a buckling structure, and more particularly to a buckling structure whose first housing and second housing are combined together via a mutual buckling between a first buckling portion of a first baffle of a first housing and a second buckling portion of a second baffle of a second housing.

2. Description of the Related Art

With rapid advance in science and technology, portable electronic device has become an indispensable device to modern people in their everydayness. Especially the portable computer has the features of slimness, compactness, portability and rechargeable battery, enabling the user to handle his or her work wherever and whenever by the computer.

The rechargeable battery is normally sealed inside a housing which is formed by attaching a first housing with a second housing. The process of sealing the rechargeable battery inside the housing includes the following steps. Firstly, the rechargeable battery is placed at an accommodation space of the second housing. Then, the first housing is used to cover up the rechargeable battery with the top end of the first lateral plate of the first housing being aligned with the top of the second lateral plate of the second housing. Then, a rib, which is formed at the top of the first lateral plate or at the top of the second lateral plate, is irradiated by ultrasonic waves, so that the rib is melted and capable of combining the top of the first lateral plate of the first housing with the top of the second lateral plate of the second housing after the rib is solidified. Alternately, an adhesive can be applied to the top of the first lateral plate of the first housing and the top of the second lateral plate of the second housing, so that the first housing combine with the second housing tightly and inseparably. Meanwhile, the rechargeable battery is enveloped in the housing formed with the first housing and the second housing.

According to a conventional practice, ultrasonic facility is required to irradiate the rib for combining the first housing and the second housing. This practice requires the use of ultrasonic facility, thus incurring extra costs. However, another conventional practice, which applies an adhesive to the first housing and the second housing for attaching the first housing and the second housing, also incurs the costs of pasting facility and adhesives. Moreover, if the rib is not evenly irradiated by ultrasonic waves or if the adhesives are is not applied evenly, the first housing and the second housing will be only loosely combined and detached easily. Apart from the rechargeable battery mentioned above, many housings, formed either by irradiating the rib with ultrasonic waves or by applying an adhesive to the first housing and the second housing, also are faced with the same problems as mentioned above.

### SUMMARY OF THE INVENTION

It is therefore the object of the invention to provide a buckling structure. The design of a mutual buckling in the housing enables the first housing and the second housing to be tightly combined without irradiating ultrasonic waves or applying an adhesive between the first housing and the second housing. The first housing is combined with the second housing by buckling structure so as to shake off the fetters of conventional way.

According to an embodiment of the invention, a buckling structure for buckling a first housing and a second housing is provided. The first housing has a lateral plate. The buckling structure includes a first baffle and a second baffle. The first baffle, which is disposed in the first housing and is substantially parallel with lateral plate, has a first buckling portion. The second baffle is disposed in the second housing and has a second buckling portion corresponding to the first buckling portion. The first buckling portion is for buckling with the second buckling portion when the second baffle is inserted between the first baffle and the lateral plate, so that the first housing and the second housing are combined tightly.

According to another embodiment of the invention, a buckling structure for buckling a first housing and a second housing is provided. The first housing has a first bottom plate and a first lateral plate, while the second housing has a second bottom plate and a second lateral plate. The first lateral plate and the second lateral plate respectively are vertically disposed on the first bottom plate and the second bottom plate. The buckling structure includes a first baffle and a second baffle. The first baffle, which is disposed on first bottom plate and substantially parallel with the first lateral plate, has a first buckling portion. The second baffle is disposed in the top end of the second lateral plate and has a second buckling portion corresponding to the first buckling portion. The first buckling portion is for buckling with the second buckling portion when the second baffle is inserted between the first baffle and the lateral plate, so that the first housing and the second housing are combined tightly.

According to yet another embodiment of the invention, a housing including a second housing and a first housing is provided. The first housing includes a first bottom plate, a first lateral plate and a first baffle. The first lateral plate is vertically disposed on the first bottom plate. The first baffle, which is disposed on the first bottom plate and is substantially parallel with the first lateral plate, has a first buckling portion. The first housing includes a second bottom plate, a second lateral plate and a second baffle. The second lateral plate is vertically disposed on the second bottom plate. The second baffle is disposed in the top end of the second lateral plate and has a second buckling portion corresponding to the first buckling portion. The first buckling portion is for buckling with the second buckling portion when the second baffle is inserted between the first baffle and the lateral plate, so that the first housing and the second housing are combined tightly.

The first buckling portion and the second buckling portion disclosed above are a set of a hook and a slot or other buckling structures.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is an exploded sectional view of a housing with a buckling structure according to a first embodiment of the invention;

FIG. 2 is an inverted 3-D diagram of the first housing of FIG. 1;

FIG. 3 is a 3-D diagram of the second housing of FIG. 1;

FIG. 4 is an assembly sectional view of a housing with a buckling structure according to a first embodiment of the invention;

FIG. 5 is an exploded sectional view of a housing with a buckling structure according to a second embodiment of the invention; and

FIG. 6 is an assembly sectional view of a housing with a buckling structure according to a second embodiment of the invention.

### DETAILED DESCRIPTION OF THE INVENTION

A buckling structure for buckling a first housing and a second housing is disclosed. The first housing has a first lateral plate. The buckling structure includes a first baffle and a second baffle. The first baffle is disposed in the first housing and is substantially parallel with the first lateral plate. The first baffle has a first buckling portion. The second baffle is disposed in the second housing and has a second buckling portion corresponding to the first buckling portion. The first buckling portion is for buckling with the second buckling portion when the second baffle is inserted between lateral plate and first baffle, so that the first housing and the second housing are combined tightly.

The buckling structure greatly shakes off the fetters of conventional way of using an ultrasonic wave to irradiate the rib or applying an adhesive for the first housing and the second housing to be combined tightly. As for the application and the structural design of the buckling structure are exemplified below by way of accompanying drawings and in terms of a first embodiment and a second embodiment.

### FIRST EMBODIMENT

Referring to FIG. 1, an exploded sectional view of a housing with a buckling structure according to a first embodiment of the invention is shown. In FIG. 1, a housing 10 includes a first housing 11, a second housing 21 and a buckling structure. The buckling structure is for buckling the first housing 11 and the second housing 21 to be combined together tightly and inseparably. As for the structural design of the buckling structure according to the embodiment is elaborated and exemplified below.

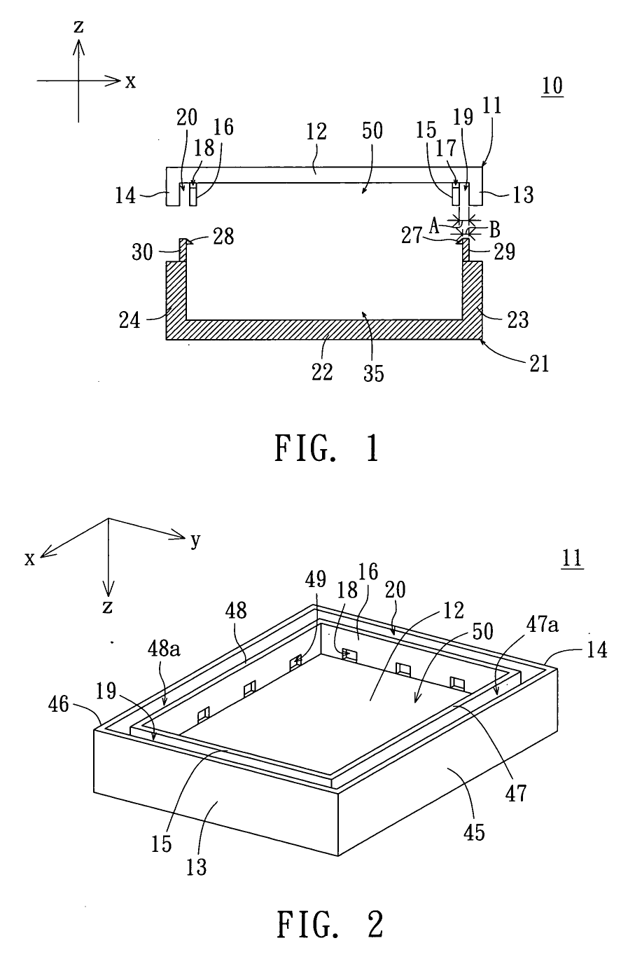

Refer to FIGS. 1˜2. FIG. 2 is an inverted 3-D diagram of the first housing of FIG. 1. In FIG. 2, the inverted structure of the first housing of FIG. 1 is viewed from the y-direction along the xz-sectional plane. The first housing 11 includes a first bottom plate 12, first lateral plates 13, 14, 45 and 46, and first baffles 15, 16, 47 and 48. The first lateral plates 13, 14, 47 and 48 are all vertically disposed on first bottom plate 12 with the first lateral plates 13 and 45 are respectively opposite to the lateral plates 14 and 46. In one embodiment, the first lateral plates 13 and 14 connect the first lateral plates 45 and 46. The first lateral plates 13, 14, 45 and 46 form a first surrounding lateral plate. The first baffles 15, 16, 47 and 48 are all vertically disposed on the first bottom plate 12 and are surrounded by the first lateral plates 13, 14, 45 and 46. The first baffles 15 and 47 are respectively opposite to the first baffles 16 and 48. In one embodiment, the first baffles 15 and 16 connect the first baffles 47 and 48. The first baffles 15, 16, 47 and 48 form a first surrounding baffle, which is surrounded by the first surrounding lateral plate formed by the first lateral plates 13, 14, 45 and 46.

The first baffle 15 is substantially parallel with the first lateral plate 13 in an interval of a clearance 19. The first baffle 16 is substantially parallel with the first lateral plate 14 in an interval of a clearance 20. The first baffle 47 is substantially parallel with the first lateral plate 45 in an interval of a clearance 47a. The first baffle 48 is substantially parallel with the first lateral plate 46 in an interval of a clearance 48a. The height of the first baffles 15, 16, 47 and 48 on the first bottom plate 12 are respectively smaller than or equal to that of the first lateral plates 13, 14, 45 and 46 on the first bottom plate 12. The clearances 19, 20, 47a and 48a can connect to form a surrounding clearance. The first baffles 15, 16, 47 and 48 and the first bottom plate 12 define a first housing accommodation space 50.

The first baffles 15, 16, 47 and 48 respectively have at least a first buckling portion, which can be but is not limited to a structural design of a slot. In the present embodiment, the first baffle 16 can have three discrete slots 18 penetrating through the first baffles 16, while the first baffle 48 can have three discrete slots 49 penetrating through the first baffle 48. Besides, the first baffle 15 has at least a slot 17, such as three slots 17 for instance, penetrating through the first baffle 15. Besides, the first baffle 47 has at least a slot, such as three slots for instance, penetrating through the first baffle 47. Therefore, the slots 17, 18 and 49 and the slot disposed on the first baffle 47 form the first buckling portion of the buckling device of the embodiment disposed in the first baffles 15, 16, 47 and 48 of the first housing 11. The shape, the number and the size of the slots 17, 18 and 49 are not limited but are determined according to actual needs.

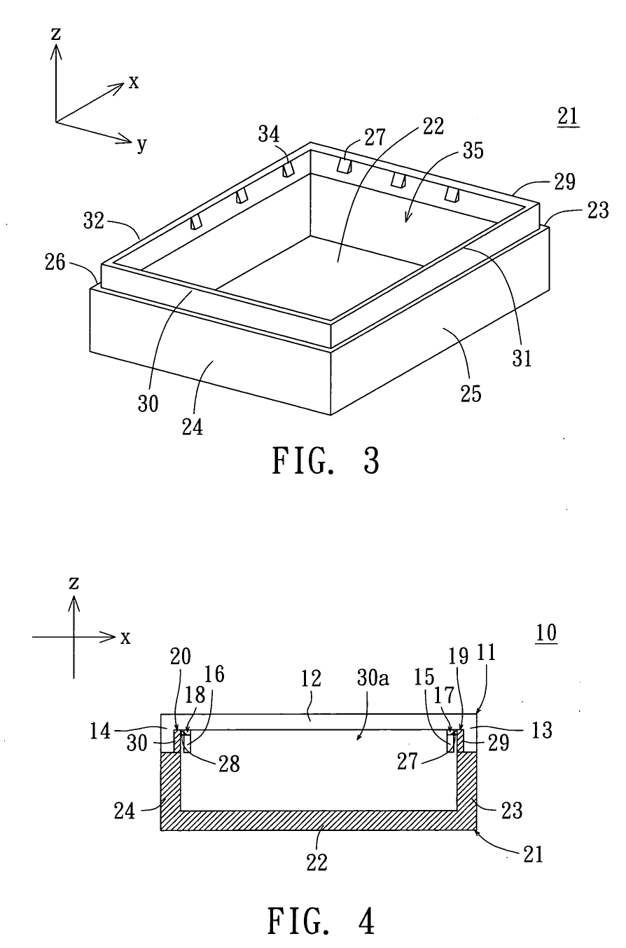

Referring to FIG. 1 and FIG. 3. FIG. 3 is a 3-D diagram of the second housing of FIG. 1. In FIG. 3, the second housing of FIG. 1 is viewed from the y-direction along the xz-sectional plane. The second housing 21 includes a second bottom plate 22, second lateral plates 23, 24, 25 and 26, and second baffles 29, 30, 31 and 32. The second lateral plates 23, 24, 25 and 26 are all vertically disposed on second bottom plate 22 with the second lateral plates 23 and 25 being respectively opposite to the second lateral plates 24 and 26. In one embodiment, the second lateral plates 23 and 24 connect the lateral plates 25 and 26. The second lateral plates 23, 24, 25 and 26 form a second surrounding lateral plate. The second baffles 29, 30, 31 and 32 are respectively vertically disposed in the top end of the second lateral plates 23, 24, 25 and 26, and respectively project from the top end of the second lateral plates 23, 24, 25 and 26 along the z-direction. The second baffles 29 and 31 are respectively opposite to the second baffles 30 and 32. In one embodiment, the second baffles 29 and 30 connect the baffles 31 and 32. Besides, the second baffles 29, 30, 31 and 32 form a second surrounding baffle positioned in the top end of a second surrounding lateral plate formed by the second lateral plates 23, 24, 25 and 26. The second baffles 29, 30, 31 and 32 and the second bottom plate 22 define a second housing accommodation space 35.

The second baffles 29, 30, 31 and 32 respectively have at least a second buckling portion, which can be but is not limited to a structural design of a hook. In the embodiment, the second baffle 29 can have three hooks 27 corresponding to the slot 17, while the second baffle 30 can have three hooks 28 corresponding to the slot 18. In one embodiment, both the hooks 27 and the hooks 28 are discretely arranged. Besides, the second baffle 31 also has at least a discretely arranged hook corresponding to the slot 49. Moreover, the second baffle 32 has three hooks 34 corresponding to the slot disposed on the first baffle 47. Therefore, the hooks 27, 28, 33 and 34 form the second buckling portion of the buckling device of the housing of the embodiment disposed in the second housing 21. The shape, the number and the size of the hooks 27, 28, 33 and 34 are not limited but are determined according to actual needs provided the hooks can be combined tightly with the slots 17, 18 and 49 and the slot disposed on the first baffle 47 to achieve the buckling function. Besides, the structural design of the first buckling portion and the second buckling portion are not limited to the above disclosure. Any design will do as long as the buckling function of the invention can be achieved.

Refer to FIG. 1 again. The thickness of the second baffles 29, 30, 31 and 32 are respectively smaller than or equal to that of the clearances 19, 20, 47a and 48a, so that the hooks 27 and 28, the hook disposed on the second baffle 31 and the hook 34 are respectively for buckling with the slots 17, 18 and 49 and the slot disposed on the first baffle 47. For example, the thickness B of the second baffle 29 is smaller than or equal to the interval A (the clearance 19) between the first baffle 15 and first lateral plate 13. This relationship can be expressed as B≦A. Consequently, the second baffle 29 can be easily inserted into the clearance 19 for the hook 27 and the slot 17 to be buckled together.

As shown in FIG. 4, the hooks 27 and 28, the hook disposed on the second baffle 31, and the hook 34 are respectively buckled with the slots 17, 18 and 49, and the slot disposed on the first baffle 47 when the second baffles 29, 30, 31 and 32 of FIG. 3 are correspondingly inserted into the clearances 19, 20, 47a and 48a of FIG. 2, so that the first housing 11 and the second housing 21 are combined together tightly and inseparably. The first housing 11 and the second housing 21 together define a closed space 30a. The closed space 30a formed by connecting a first housing accommodation space 50 and a second housing accommodation space 35 is used to accommodate an element placed in the second housing accommodation space 35 in advance. The element can be a battery for instance.

However, anyone who is skilled in the related technology will understand that the invention is not limited thereto. For example, the first bottom plate 12, the first lateral plates 13, 14, 45 and 46, and the first baffles 15, 16, 47 and 48 can be an one-piece structure. Besides, the second bottom plate 22, the second lateral plates 23, 24, 25 and 26, the second baffles 29, 30, 31 and 32, the hooks 27 and 28, the hook disposed on the second baffle 31, and the hook 34 can be an one-piece structure. Besides, given that the first baffles 29, 30, 31 and 32 are correspondingly inserted into the clearances 19, 20, 47a and 48a and that the hooks 27 and 28, the hook disposed on the second baffle 31, and the hook 34 are buckled with the slots 17, 18 and 49, the slot disposed on the first baffle 47, the first baffles 15, 16, 47 and 48, the second baffles 29, 30, 31 and 32, the hooks 27 and 28, the hook disposed on the first baffle 31, and the hook 34 can be made of a flexible material such as flexible rubber, flexible plastics or flexible high polymers for instance.

The first baffle 15 having the slot 17 is disposed at an appropriate distance on an inner side of the first lateral plate 13. The slot 17 is buckled with the hook 27 of the second baffle 29. If a corner of the first housing 11 is hit by an external force when the first baffle 15 is buckled together with the second baffle 29, the first lateral plate 13 absorbing an external force would be deformed and expanded. However, the first baffle 15 would still be buckled together with the second baffle 29 without being deformed. So, the buckling structure according to the present embodiment, such as the first baffle 15 and the slot 17 disposed thereon or the second baffle 29 and the hook 27 disposed thereon, enables the first housing 11 and the second housing 21 to be tightly combined.

### SECOND EMBODIMENT

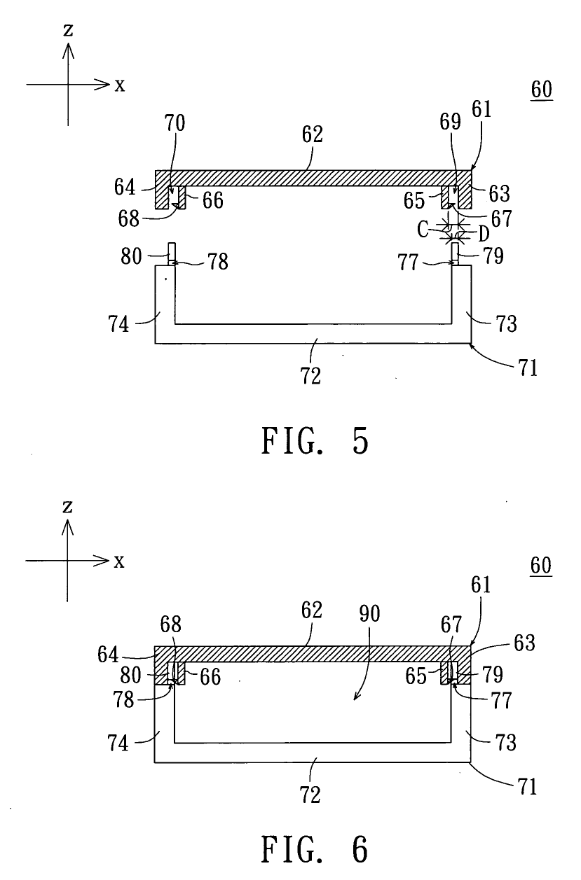

Referring to FIG. 5, an exploded sectional view of a housing with a buckling structure according to a second embodiment of the invention is shown. In FIG. 5, a housing 60 includes a first housing 61, a second housing 71 and a buckling structure. The buckling structure is for buckling the first housing 61 and the second housing 71 to be combined together tightly and inseparably. As for the structural design of the buckling structure according to the embodiment is elaborated and exemplified below.

The first housing 61 includes at least a first bottom plate 62, first lateral plates 63 and 64, and first baffles 65 and 66. The first lateral plates 63 and 64 are both vertically disposed on the first bottom plate 12. The first lateral plate 63 is opposite to the first lateral plate 64. The first baffles 65 and 66 are both vertically disposed on the first bottom plate 62. The first baffles 65 and 66 are positioned between the first lateral plate 63 and the lateral plate 64. The first baffle 65 is opposite to the first baffle 66. The first baffles 65 and 66 are respectively adjacent to the first lateral plates 63 and 64. The first baffle 65 is substantially parallel with the first lateral plate 63 in an interval of a clearance 69. The first baffle 66 is substantially parallel with the first lateral plate 64 in an interval of a clearance 70. The height of the first baffles 65 and 66 on the first bottom plate 62 are respectively smaller than or equal to the height of the first lateral plates 63 and 64 on the first bottom plate 62. Besides, the first lateral plates 63 and 64 can form a first surrounding lateral plate together with other first lateral plates not shown in FIG. 5, while the first baffle 65 and 66 can form a first surrounding baffle together with other first baffles not shown in FIG. 5 and is surrounded by the first surrounding lateral plate.

The first baffles 65 and 66 respectively have at least a first buckling portion, which can be but is not limited to a structural design of a hook. In the embodiment, the first baffle 65 has at least a hook 67, and the first baffle 66 has at least a hook 68. Therefore, the hooks 67 and 68 are the first buckling portion of the housing buckling device of the embodiment disposed in the first housing 61. The shape, the number and the size of the hooks 67 and 68 are not limited but are determined according to actual needs.

The second housing 71 at least includes a second bottom plate 72, second lateral plates 73 and 74, and second baffles 79 and 80. The second lateral plate 73 and 74 are both vertically disposed on second bottom plate 72. The second lateral plate 73 is opposite to the second lateral plate 74. The second baffles 79 and 80 respectively are vertically disposed in the top end of the second lateral plates 73 and 74, and respectively project from the top end of the second lateral plates 73 and 74 along the z-direction. The second baffle 79 is opposite to the second baffle 80. Besides, the second lateral plates 73 and 74 can form a second surrounding lateral plate together with other second lateral plates not shown in FIG. 5, while the second baffle 79 and 80 can form a second surrounding baffle together with other second baffles not shown in FIG. 5 and is surrounded by the second surrounding lateral plate.

The second baffles 79 and 80 respectively have at least a second buckling portion, which can be but is not limited to be a structural design of a slot. In the embodiment, the second baffle 79 has at least a slot 77 corresponding to the hook 67. The slot 77 can penetrate through the second baffle 79. The second baffle 80 has at least a slot 78 corresponding to the hook 68. The slot 78 can penetrate through the second baffle 80. Therefore, the slots 77 and 78 are the second buckling portion of the buckling device of the housing of the embodiment disposed in the second housing 71. The shape, the number and the size of the slots 77 and 78 are not limited but are determined according to actual needs provided the slots 77 and 78 can be combined tightly with the hooks 67 and 68 to achieve the buckling function of the invention. Besides, the structural design of the first buckling portion and the second buckling portion are not limited to the above disclosure. Any design will do as long as the buckling function of the invention can be achieved.

The thickness of the second baffles 79 and 80 are respectively smaller than or equal to the clearances 69 and 70, so that the hooks 67 and 68 can respectively be buckled with the slots 77 and 78. For example, the thickness D of the second baffle 79 is smaller than or equal to the interval C (the clearance 69) between the first baffle 65 and the first lateral plate 63. This relationship can be expressed as D≦C. Consequently, the second baffle 79 can be easily inserted into the clearance 69 for the hook 67 and the slot 77 to be buckled together.

As shown in FIG. 6, the hooks 67 and 68 are respectively buckled with the slots 77 and 78 when the second baffles 79 and 80 are correspondingly inserted into the clearances 69 and 70, the first housing 61 and the second housing 71 are combined together tightly and inseparably. The first housing 61 and the second housing 71 define a closed space 90 for accommodating an element such as a battery for instance.

However, anyone who is skilled in the technology of the invention will understand that the technology of the invention is not limited thereto. For example, the first bottom plate 62, the first lateral plates 63 and 64, the first baffles 65 and 66, and the hooks 67 and 68 can be an one-piece structure. Besides, the second bottom plate 72, the second lateral plates 73 and 74, and the second baffles 79 and 80 can be an one-piece structure. Moreover, given that the second baffles 79 and 80 can correspondingly be inserted into the clearances 69 and 70 and that the hook 67 and 68 can respectively be buckled with the slots 77 and 78, the first baffles 65 and 66, the second baffles 69 and 80, and the hooks 67 and 68 can be made of a flexible material such as flexible rubber, flexible plastics or flexible high polymers.

The first baffle 65 having the hook 67 is disposed at an appropriate distance on an inner side of the first lateral plate 63. The hook 67 is buckled with the slot 77 of the second baffle 79. If a corner of the first housing 61 is hit by an external force when the first baffle 65 has been buckled together with the second baffle 79, the first lateral plate 63 absorbing an external force would be deformed and expanded. However, the first baffle 65 would still be buckled together with the second baffle 79 without being deformed. So, the buckling structure according to the present embodiment, such as the first baffle 65 and the hook 67 disposed thereon or the second baffle 79 and the slot 77 disposed thereon, enables the first housing 61 and the second housing 71 to be tightly combined.

The advantages of the buckling structure according to the embodiments of the invention are disclosed below.

1. The design of a mutual buckling between a first buckling portion of the first baffle of the first housing and a second buckling portion of the second baffle of the second housing enables the first housing and the second housing to be tightly combined without irradiating the rib with ultrasonic waves or applying an adhesive between the first housing and the second housing. The invention greatly shakes off the fetters of conventional way of using an ultrasonic wave to irradiate the rib or applying an adhesive for the first housing and the second housing to be combined tightly.

2. The invention combines the first housing and the second housing without irradiating the rib with an ultrasonic wave, not only saving the costs of ultrasonic facility but also avoiding the detachment problem between the first housing and the second housing due to uneven irradiation of ultrasonic waves that would arise in a conventional practice, thus greatly cementing the attachment between the first housing and the second housing.

3. The invention combines the first housing and the second housing without applying any adhesives between the first housing and the second housing, not only saving the costs of adhering facility and adhesives but also avoiding the problem of detachment between the first housing and the second housing due to uneven application of adhesives that would arise in a conventional practice, greatly cementing the attachment between the first housing and the second housing.

4. If a corner of the first housing is hit by an external force when the first baffle has been buckled with the second baffle, the first lateral plate absorbing the external force would be deformed and expanded. The first baffle has a first buckling portion and is disposed at an appropriate distance on an inner side of the first lateral plate, while the second baffle has a second buckling portion. However, the first baffle would still be tightly buckled with the second baffle without being deformed. So, the buckling structure according to the invention enables the first housing and the second housing to be tightly combined.

5. The buckling structure of the invention can be applied to the housing of many products for the first housing and the second housing to be combined tightly to avoid the problems associated with conventional ways of using an ultrasonic wave to irradiate the rib or applying an adhesive for the first housing and the second housing to be combined tightly.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A buckling structure for buckling a first housing and a second housing, wherein the first housing has a lateral plate, the buckling structure comprises:
a first baffle, which is disposed in the first housing and substantially parallel with the lateral plate, wherein the first baffle has a first buckling portion; and
a second baffle, which is disposed in the second housing and has a second buckling portion corresponding to the first buckling portion, wherein the first buckling portion is for buckling with the second buckling portion when the second baffle is inserted between the lateral plate and the first baffle, so that the first housing and the second housing are combined tightly.

2. The buckling structure according to claim 1, wherein the first buckling portion and the second buckling portion respectively are a hook and a slot.

3. The buckling structure according to claim 1, wherein the first buckling portion and the second buckling portion respectively are a slot and a hook.

4. The buckling structure according to claim 1, wherein the thickness of the second baffle is smaller than or equal to the interval between the lateral plate and the first baffle.

5. The buckling structure according to claim 1, wherein the first housing and the second housing define a closed space when combined together.

6. A buckling structure for buckling a first housing and a second housing, wherein the first housing has a first bottom plate and a first lateral plate, the second housing has a second bottom plate and a second lateral plate, the first lateral plate and the second lateral plate respectively are vertically disposed on the first bottom plate and the second bottom plate, the buckling structure comprises:
a first baffle, which is disposed in the first bottom plate and substantially parallel with the first lateral plate, wherein the first baffle has a first buckling portion; and
a second baffle, which is disposed in the top end of the second lateral plate and has a second buckling portion corresponding to the first buckling portion, wherein the first buckling portion is for buckling with the second buckling portion when the second baffle is inserted between the first lateral plate and the first baffle, so that the first housing and the second housing are combined tightly.

7. The buckling structure according to claim 6, wherein the thickness of the second baffle is smaller than or equal to the interval between the first lateral plate and the first baffle.

8. The buckling structure according to claim 6, wherein the first housing and the second housing define a closed space when combined together.

9. The buckling structure according to claim 6, wherein the first buckling portion and the second buckling portion respectively are a hook and a slot.

10. The buckling structure according to claim 6, wherein the first buckling portion and the second buckling portion respectively are a slot and a hook.

11. A housing, comprising:
a first housing, comprising:
a first bottom plate;
a first lateral plate vertically disposed on the first bottom plate; and
a first baffle, which is disposed in the first bottom plate and substantially parallel with the first lateral plate, wherein the first baffle has a first buckling portion; and
a second housing, comprising:
a second bottom plate;
a second lateral plate vertically disposed on the second bottom plate; and
a second baffle, which is disposed in the top end of the second lateral plate and has a second buckling portion corresponding to the first buckling portion, wherein the first buckling portion is for buckling with the second buckling portion when the second baffle is inserted between the first lateral plate and the first baffle, so that the first housing and the second housing are combined tightly.

12. The housing according to claim 11, wherein the thickness of the second baffle is smaller than or equal to the interval between the first lateral plate and the first baffle.

13. The housing according to claim 11, wherein the first housing and the second housing define a closed space when combined together.

14. The housing according to claim 11, wherein the first buckling portion and the second buckling portion respectively are a hook and a slot.

15. The housing according to claim 11, wherein the first buckling portion and the second buckling portion respectively are a slot and a hook.
